(19) United States
(12) Patent Application Publication
(10) Pub. No.: US 2009/0147140 A1
(43) Pub. Date: Jun. 11, 2009

(54) IMAGE APPARATUS FOR PROCESSING PLURALITY OF IMAGES AND CONTROL METHOD THEREOF

(75) Inventor: Jae-won KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/171,649

(22) Filed: Jul. 11, 2008

(30) Foreign Application Priority Data
Dec. 6, 2007 (KR) 10-2007-0126045

(51) Int. Cl. H04N 5/45; H04N 5/50

(52) U.S. Cl. 348/565; 348/569; 348/E05.097; 348/E05.112

(57) ABSTRACT

An image apparatus for processing a plurality of images and a control method thereof are provided. The control method includes determining whether a channel change command is input, while only a first broadcast received via a first channel is being displayed; if it is determined that the channel change command is input, displaying a composite image including the first broadcast and a second broadcast received via a second channel; and selectively displaying only the second broadcast after the displaying the composite image.

### CROSS-REFERENCE TO RELATED APPLICATIONS

This application claims priority from Korean Patent Application No. 10-2007-0126045, filed on Dec. 6, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to processing a plurality of images and controlling an image apparatus, and more particularly, to providing an image apparatus which processes a plurality of images, and controlling the image apparatus.

2. Description of the Related Art

Image apparatuses play back or record broadcasts, images recorded on recording media, or images transmitted from external sources. The rapid development of imaging or broadcasting technologies has enabled users to access a wide variety of content using image apparatuses. In particular, as a result of the emergence of digital televisions (DTVs) and Internet TVs, users can be provided with large amounts of content via TVs.

Accordingly, while viewing a specific image, for example a broadcast received via a specific channel, if a user enters a channel change command in order to view another broadcast received via another channel, only a broadcast provided in response to the channel change command is displayed on a full screen, and the broadcast previously viewed by the user disappears. Therefore, the screen of the image apparatus changes every time channel change commands are input, so it is impossible for the user to continue to view the broadcast that the user was viewing previously.

Additionally, if a user determines that a broadcast provided in response to the channel change command is not a desired broadcast, and if the user desires to view a broadcast received via a previous channel again, the user is unable to view the whole broadcast received via the previous channel.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image apparatus and a control method thereof, in which a user may search for a desired image while continuing to view a currently viewed image, so it is possible to satisfy user viewing satisfaction.

According to an aspect of the present invention, there is provided a method for controlling an image apparatus, the method comprising determining whether a channel change command is input, while a first broadcast received via a first channel is being displayed; if it is determined that the channel change command is input, receiving the first broadcast together with a second broadcast, which is received in response to the channel change command; displaying a composite image in which the first broadcast is set to be a main image and the second broadcast is set to be a sub-image; and receiving and displaying only the second broadcast after displaying the composite image.

The displaying the composite image may further comprise determining whether another channel change command is input, while the composite image is being displayed; if it is determined that the other channel change command is input, receiving the first broadcast together with a third broadcast, which is received in response to the other channel change command; and displaying a composite image in which the first broadcast is set to be a main image and the third broadcast is set to be a sub-image.

Only the third broadcast may be received and displayed instead of the second broadcast.

The sub-image may be displayed in a picture-in-picture (PIP) form.

The receiving and displaying only the second broadcast may comprise, if it is determined that a command to confirm display of a second channel is input, receiving and displaying only the second broadcast.

The receiving and displaying only the second broadcast may further comprise automatically setting the second broadcast, which has been the sub-image, to be a main image and displaying only the second broadcast.

The receiving and displaying only the second broadcast may further comprise, if a predetermined period of time has elapsed after the composite image is displayed, receiving and displaying only the second broadcast.

According to another aspect of the present invention, there is provided an image apparatus comprising a receiver which receives a broadcast; a display unit which displays the broadcast; and a controller which, if it is determined that a channel change command is input, while a first broadcast received via a first channel is being displayed, controls the receiver and the display unit to simultaneously receive the first broadcast and a second broadcast, which is received in response to the channel change command, and to display a composite image comprising the first broadcast and the second broadcast.

The composite image may be displayed so that the first broadcast may be set to be a main image and the second broadcast may be set to be a sub-image.

The sub-image may be displayed in a PIP form.

If it is determined that a command to confirm display of a second channel is input while the composite image is being displayed, the controller may control the receiver and the display unit so that only the second broadcast may be received and displayed.

If there is no command input by a user for a predetermined period of time, the controller may control the receiver and the display unit so that only the second broadcast may be received and displayed, in the same manner when the command to confirm display of the second channel is input.

If it is determined that another channel change command is input while the composite image is being displayed, the controller may control the receiver and the display unit to simultaneously receive the first broadcast and a third broadcast, which is received in response to the other channel change command, and to display a composite image comprising the first broadcast and the third broadcast.

According to another aspect of the present invention, there is provided a method for controlling an image apparatus, the method comprising determining whether an image source change command is input, while a first image is being displayed; if it is determined that the image source change command is input, displaying a composite image comprising the first image and a second image which is provided in response to the image source change command; and displaying only the second image after displaying the composite image.

The sub-image may be displayed in a PIP form.

The displaying only the second image may comprise, if it is determined that a command to confirm change of an image source is input, displaying only the second image.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of an image apparatus according to an exemplary embodiment of the present invention;

FIG. 2 is a flowchart explaining a process of changing channels using a composite image, according to an exemplary embodiment of the present invention; and

FIGS. 3A to 3F are exemplary views showing broadcasts displayed on a display unit when channels are changed using a composite image, according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

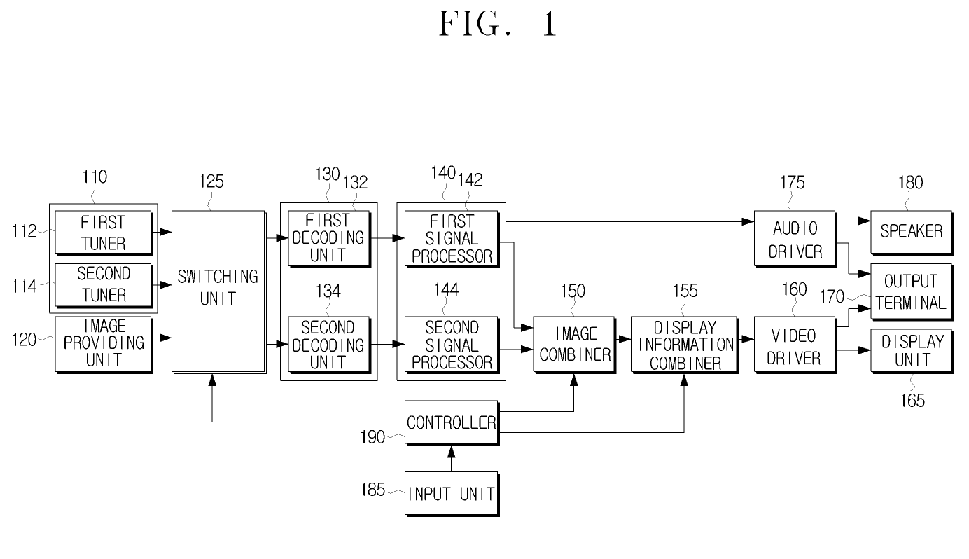

FIG. 1 is a block diagram of an image apparatus according to an exemplary embodiment of the present invention. The image apparatus of FIG. 1 comprises a broadcast receiver 110, an image providing unit 120, a switching unit 125, a decoding unit 130, a signal processor 140, an image combiner 150, a display information combiner 155, a video driver 160, a display unit 165, an output terminal 170, an audio driver 175, a speaker 180, an input unit 185 and a controller 190.

The broadcast receiver 110 receives a broadcast from a broadcast station or a satellite via wire or wirelessly. The broadcast receiver 110 may desirably include various tuners, such as a first tuner 112 and a second tuner 114, which tune between broadcasts.

The image providing unit 120 may be any of various types of recording mediums, such as a hard disc drive (HDD) or a flash memory, which stores images or outputs the stored images. Additionally, the image providing unit 120 may be a communication interface through which the image apparatus is communicably connected to an external apparatus which provides images.

The switching unit 125 performs a switching operation so that the data output from at least one of the broadcast receiver 110 and the image providing unit 120 may be transferred to the decoding unit 130. The switching operation of the switching unit 125 may be controlled by the controller 190.

Specifically, the switching unit 125 may transfer a broadcast received by the first tuner 112 to the decoding unit 130 and simultaneously transfer a broadcast received by the second tuner 114 to the decoding unit 130. Additionally, while transferring a broadcast received by the first tuner 112 to the decoding unit 130, the switching unit 125 may transfer an image output from the image providing unit 120 to the decoding unit 130.

The decoding unit 130 decodes a compressed image from among images output from the switching unit 125, and transfers the decoded image to the signal processor 140. The decoding unit 130 comprises a first decoding unit 132 and a second decoding unit 134. For example, if a first image is received from the switching unit 125, the first decoding unit 132 may decode the first image, and if a second image is further received from the switching unit 125 while the first decoding unit 132 decodes the first image, the second decoding unit 134 decodes the second image.

If a user inputs a command to stop playback of the image transferred to the first decoding unit 132, the first decoding unit 132 may stop decoding of the image. If an image other than the image decoded by the second decoding unit 134 is received from the switching unit 125, the first decoding unit 132 may decode the received image. Therefore, the first decoding unit 132 and the second decoding unit 134 may be in a complementary relationship, rather than acting separately as a main decoding unit and a sub-decoding unit, respectively.

The signal processor 140 performs signal processing so that the images decoded by the decoding unit 130 may be played back. The signal processor 140 includes a first signal processor 142 and a second signal processor 144. The first signal processor 142 and the second signal processor 144 perform signal processing so that the image decoded by the first decoding unit 132 and the image decoded by the second decoding unit 134 respectively may be played back.

The signal processor 140 transfers video signals and audio signals of images to the image combiner 150 and the audio driver 175, respectively. If the signal processor 140 processes two different images into signals, two different video signals may be transferred to the image combiner 150, but only a single audio signal of two different audio signals may be transferred to the audio driver 175.

For example, if the signal processor 140 processes a single image, an audio signal of the processed image may be transferred to the audio driver 175. However, if the signal processor 140 receives two images and processes the two images, only the audio signal of the image that is processed first between the two images may be transferred to the audio driver 175. In this exemplary embodiment, video signals are mainly described and are referred to as images. Additionally, broadcasts may also be contained in images.

The image combiner 150 combines the images processed by the signal processor 140. If a single image is output from the signal processor 140, there is no need to combine images. Alternatively, if a plurality of images are output from the signal processor 140, the image combiner 150 may combine the plurality of images so that one image from among the plurality of images may be set to be a main image and other images may be set to be sub-images. Here, the image combiner 150 may combine the plurality of images according to the control of the controller 190.

The display information combiner 155 combines display information, such as characters, symbols, figures and graphics, with the image output from the image combiner 150. In this case, the display information combiner 155 can combine the display information by using an on-screen display (OSD) method. The combining operation of the display information combiner 155 is also controlled by the controller 190.

The video driver 160 displays an image output from the display information combiner 155 on the display unit 165, or transmits the image to another external apparatus (not shown) connected through the output terminal 170. The audio driver 175 outputs the audio signal output from the signal processor 140 through the speaker 180, or transmits the audio signal to another external apparatus (not shown) connected through the output terminal 170.

The input unit 185 may be provided integrally with or separately from the image apparatus, and may receive user operating commands and transmit the received commands to the controller 190. Additionally, the input unit 185 may be implemented as a remote controller for a user to input the operating commands, and a light receiver which receives an output signal of the remote controller to transmit the signal to the controller 190. The input unit 185 may also be implemented as a user interface through which a user can enter the commands using a menu screen.

The controller 190 controls the entire operation of the image apparatus according to the user operating commands which are entered through the input unit 185.

In more detail, while a certain image (hereinafter, referred to as a first image) is being played back, if a command to play back another image (hereinafter, referred to as a second image) is input, the controller 190 may control the switching unit 125 to transfer the second image to the decoding unit 130 through a switching operation. Additionally, the controller 190 may control the decoding unit 130 and signal processor 140 to decode and process the first image and the second image. The controller 190 may also control various function blocks of the image apparatus so that the first image and the second image may be combined to form a main image and a sub-image, respectively, and that the first image and second image may be simultaneously output.

If a command to change to the second image is input, or if a predetermined period of time has elapsed, the controller 190 may control the various function blocks of the image apparatus to output only the second image. Additionally, if a command to play back an image (hereinafter, referred to as a third image) other than the second image is input, the controller 190 may control the function blocks of the image apparatus so that a composite image generated by combining the first image as a main image with the third image as a sub-image may be displayed.

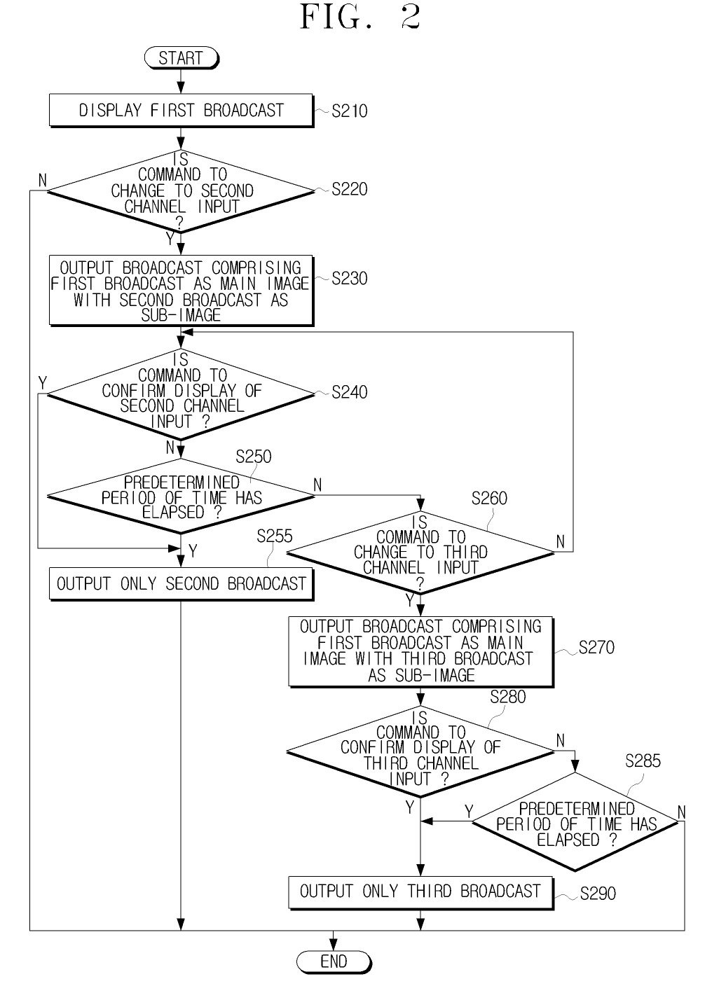

Hereinafter, a process of changing channels using a composite image will be described in detail with reference to FIG. 2. FIG. 2 is a flowchart explaining a process of changing channels using a composite image, according to an exemplary embodiment of the present invention.

In FIG. 2, a first broadcast received via a first channel is currently displayed on the image apparatus (operation S210). In this exemplary embodiment of the present invention, a user may select a desired channel using buttons included in the input unit 185 or using a menu screen. The controller 190 may then cause a broadcast received via the selected channel to be displayed.

In more detail, the first tuner 112 of the broadcast receiver 110 may tune to the channel selected by the user. A broadcast received through the channel may be transferred to the decoding unit 130 through the switching unit 125, and the decoding unit 130 may then decompress the received broadcast. Images of the broadcast may be processed by the signal processor 140 and may then be displayed by the video driver 160 and the display unit 165. Audio signals of the broadcast may be processed by the signal processor 140 and may then be output by the audio driver 175 and the speaker 180.

Subsequently, the controller 190 determines whether a command to change to a second channel is input (operation S220). Here, the second channel refers to a channel other than the first channel. If the user desires to view a second broadcast received via the second channel, the user may input the command to change to the second channel by pressing a channel number button of the input unit 185 which corresponds to the second channel. The controller 190 may then determine that the command to change to the second channel is input.

If it is determined that the command to change to the second channel is input (operation S220-Y), the controller 190 may control the various function blocks of the image apparatus so that a composite image generated by combining the first broadcast as a main image with the second broadcast as a sub-image may be output (operation S230). Specifically, the second tuner 114 may tune to the second channel and transfer the second broadcast received via the second channel to the second decoding unit 134, and the second decoding unit 134 may then decode the second broadcast. The second signal processor 144 may then convert the decoded second broadcast into a signal of a format suitable to be played back. The image combiner 150 may generate a composite image in which the first broadcast as a main image is combined with the second broadcast as a sub-image, and may display the generated composite image on the display unit 165. Here, the sub-image may desirably be displayed in a PIP form.

The controller 190 determines whether a command to confirm display of the second channel is input (operation S240). While viewing the composite image, the user may further press a channel number button of the input unit 185 which corresponds to the second broadcast, or may press a confirm button. Accordingly, the controller 190 may determine that the command to confirm display of the second channel is input.

If it is determined that the command to confirm display of the second channel is input (operation S240-Y), the controller 190 may control the function blocks of the image apparatus so that only the second broadcast may be displayed (operation S255). In more detail, the controller 190 may generate a control signal to pause receiving the first broadcast, and may transfer the generated control signal to the first tuner 112. The image combiner 150 may output the second broadcast received from the second signal processor 144 without any combining operation. Accordingly, the second broadcast that has been shown in PIP form may be displayed on the full screen, and the first broadcast may disappear from the screen. In other words, the second broadcast may be automatically set to be a main image and displayed.

If it is determined that the command to confirm display of the second channel is not input (operation S240-N), the controller 190 may determine whether a predetermined period of time has elapsed after the command to change to the second channel has been input (operation S250). The predetermined period of time may be set at the time of manufacture of the image apparatus, or may be set manually by the user using the menu screen. For example, the predetermined period of time may desirably be approximately one minute.

If it is determined that the predetermined period of time has elapsed (operation S250-Y), the controller 190 may control the function blocks of the image apparatus so that only the second broadcast may be displayed (operation S255) in the same manner as when the command to confirm display of the second channel is input. Accordingly, although the user does not input any command using the operator after a predetermined period of time has elapsed, the controller 190 may also generate a control signal and control the function blocks of the image apparatus in the same manner as when a channel confirmation command is input.

Additionally, the controller 190 determines whether a command to change to a third channel is input before a predetermined period of time has elapsed (operation S260). In this situation, while simultaneously viewing the first broadcast and second broadcast of the composite image, the user may input the command to change to the third channel in order to view a third broadcast received via the third channel, instead of the second broadcast. Specifically, the user may input the command to change to the third channel by pressing a channel number button corresponding to the third channel, in the same manner as when the command to change to the second channel is input. The controller 190 may thus determine that the command to change to the third channel is input.

The controller 190 may then control the function blocks of the image apparatus to display a composite image in which the first broadcast and third broadcast are set respectively to be a main image and a sub-image (operation S270). Specifically, the second tuner 114 that has received the second broadcast may receive the third broadcast instead of the second broadcast, and may transfer the received third broadcast to the decoding unit 130. Next, the second decoding unit 134 may decode the third broadcast, and the second signal processor 144 may process the decoded third broadcast into a signal which is able to be played back. The image combiner 150 may then generate a composite image comprising the first broadcast received from the first signal processor 142 as a main image and the third broadcast received from the second signal processor 144 as a sub-image, so that the generated composite image may be displayed on the display unit 165.

Additionally, if it is determined that a command to confirm display of the third channel is input (operation S280-Y), or that a predetermined period of time has elapsed (operation S285-Y), the controller 190 may control the function blocks of the image apparatus so that only the third broadcast may be output (operation S290), in the same manner as operation S255.

Although not illustrated, the user may input a command to change to a fourth channel while the composite image comprising the first broadcast and third broadcast is being displayed. In this situation, a new composite image may be displayed which contains the first broadcast and a fourth broadcast, which is received via the fourth channel, instead of the third broadcast.

Accordingly, while a specific broadcast is being displayed, if the user inputs a command to change to another channel, the image apparatus may output a composite image in which the currently displayed broadcast is combined with another broadcast received in response to the input command. Therefore, the user may check whether the broadcast received in response to the input command is a desired broadcast while continuing to view the currently displayed broadcast, thereby increasing user convenience.

If the user does not desire to view the broadcast received in response to the input command, he may again change the broadcast received in response to the input command to another broadcast. Here, since the broadcast received in response to the input command is displayed in PIP form, it is possible for the user to search for the desired broadcast while continuing to view the currently displayed broadcast.

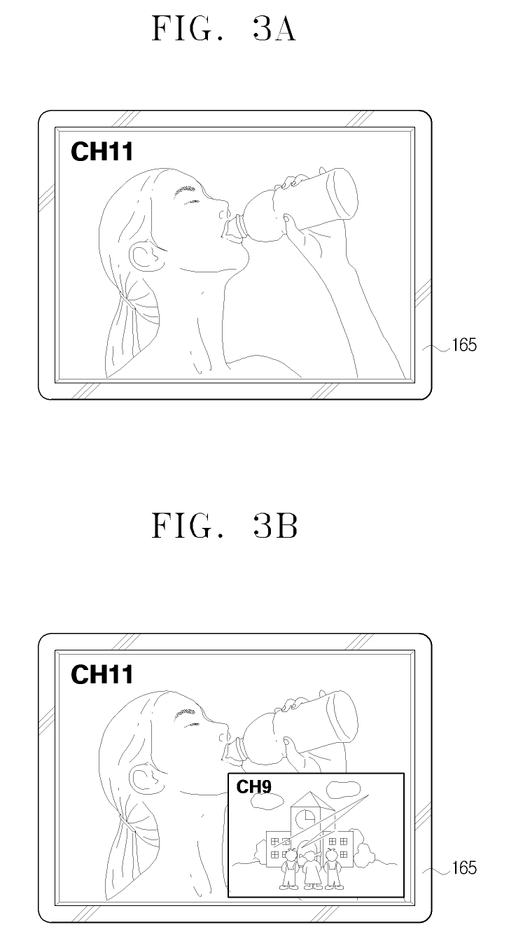

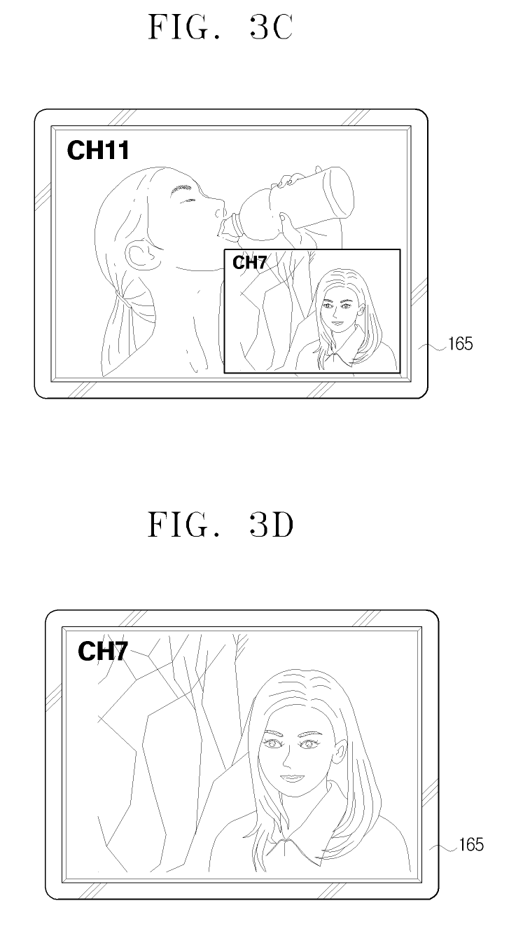

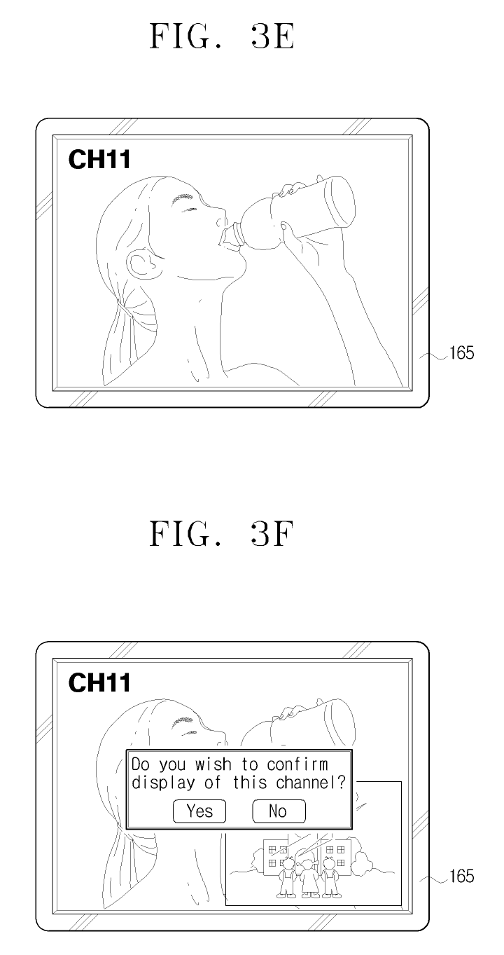

FIGS. 3A to 3F are exemplary views showing broadcasts displayed on the display unit 165 when channels are changed using a composite image, according to an exemplary embodiment of the present invention.

As shown in FIG. 3A, the user currently views a broadcast received via channel 11. In this situation, if the user inputs a command to change to channel 9, a broadcast received via channel 9 may be shown in PIP form, as shown in FIG. 3B. Additionally, if it is determined that the broadcast received via channel 9 is not a desired broadcast, the user may input a command to change to another channel, for example channel 7, before a predetermined period of time has elapsed. Accordingly, a broadcast received via channel 7 may be provided in PIP form, as shown in FIG. 3C.

Furthermore, if a predetermined period of time has elapsed, or if the user inputs a command to confirm display of channel 7, only the broadcast received via channel 7 may be displayed on full screen, as shown in FIG. 3D. Alternatively, if the user desires to continue to view the broadcast received via channel 11, the user may need to press a button of the input unit 185 which corresponds to channel 11 before a predetermined period of time has elapsed. Accordingly, only the broadcast received via channel 11 may be displayed on the full screen, as shown in FIG. 3E.

In the exemplary embodiment, if a predetermined period of time has elapsed or if a channel confirmation command is input, an image currently displayed on the display unit 165 may be changed to a broadcast received via a channel selected in response to the channel confirmation command, but the present invention is not limited thereto. Accordingly, the present invention is also applicable to a situation in which, if a predetermined period of time has elapsed or if a channel confirmation command is input, the controller 190 may generate a query message “Do you wish to confirm display of this channel?”, and transfer the query message to the display information combiner 155. The display information combiner 155 may then combine the image output from the image combiner 150 with the query message, and may output the combined image, so that an image shown in FIG. 3F may be displayed on the display unit 165.

Although only the broadcast received via the changed channel is displayed after a predetermined period of time has elapsed in the exemplary embodiment of the present invention, only the first broadcast that has been continuously viewed may be displayed instead of the broadcast received via the changed channel, even when a predetermined period of time has elapsed.

Additionally, the first broadcast and second broadcast are set to be a main image and a sub-image, respectively, in the exemplary embodiment of the present invention, but the first broadcast may be set to be a sub-image and the second broadcast may be set to be a main image. In this situation, the main image and sub-image may have the same size.

Furthermore, the situation in which the channel change and confirmation commands regarding the broadcast channels are input has been described in the exemplary embodiment of the present invention. However, the present invention is also applicable to a situation in which channel change and confirmation commands regarding broadcasts or a plurality of images stored in the image providing unit 120 are input. Here, the images and broadcasts stored in the image providing unit 120 are referred to as image sources.

Moreover, the image apparatus of FIG. 1 is merely an exemplary embodiment of the present invention, such that an image apparatus to which the present invention is applicable does not need to include all the blocks shown in FIG. 1, and unnecessary blocks may be omitted. For example, if an image apparatus is a set top box, the display unit 165 and the speaker 180 may be omitted.

As described above, according to the exemplary embodiment of the present invention, a user may search for an image, which he desires to view, while continuing to view a currently displayed image, so it is possible to increase user viewing satisfaction.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for controlling an image apparatus, the method comprising:
determining whether a channel change command is input while only a first broadcast received via a first channel is being displayed;
if it is determined that the channel change command is input, displaying a composite image including the first broadcast and a second broadcast received via a second channel; and
selectively displaying only the second broadcast after the displaying the composite image.

2. The method as claimed in claim 1, wherein the selectively displaying only the second broadcast after displaying the composite image comprises displaying only the second broadcast if a command is not input by a user while the composite image is displayed for a predetermined period of time.

3. The method as claimed in claim 2, wherein the displaying the composite image further comprises:
determining whether another channel change command is input while the composite image is being displayed;
if it is determined that the other channel change command is input, displaying another composite image including the first broadcast and a third broadcast received via a third channel.

4. The method as claimed in claim 3, further comprising displaying only the third broadcast if a command is not input by a user while the other composite image is displayed for a predetermined period of time.

5. The method as claimed in claim 1, wherein in the a composite image, the first broadcast is displayed as a main image and the second broadcast is displayed as a sub-image.

6. The method as claimed in claim 5, wherein the main image and the sub-image are displayed in a picture-in-picture (PIP) form.

7. The method as claimed in claim 1, wherein the selectively displaying only the second broadcast comprises, if a command to confirm display of a second broadcast is input while the composite image is being displayed, displaying only the second broadcast.

8. The method as claimed in claim 1, wherein the selectively displaying only the second broadcast comprises automatically displaying only the second broadcast if the composite image is continuously displayed for a predetermined period of time.

9. An image apparatus comprising:
a display unit; and
a controller which, if it is determined that a channel change command is input, while only a first broadcast received via a first channel is being displayed by the display unit, controls the display unit to display a composite image in which the first broadcast is displayed as a main image and a second broadcast received via a second channel is displayed as a sub-image, and which controls the display unit to selectively display only the second broadcast after displaying the composite image.

10. The image apparatus as claimed in claim 9, wherein in the composite image the first broadcast is displayed as a main image and the second broadcast is displayed as a sub-image.

11. The image apparatus as claimed in claim 10, wherein the main image and the sub-image are displayed in a picture-in-picture (PIP) form.

12. The image apparatus as claimed in claim 9, wherein, the controller controls the display unit to display only the second broadcast if a command to confirm display of a second channel is input while the composite image is being displayed.

13. The image apparatus as claimed in claim 9, wherein the controller controls the display unit to display only the second broadcast if a command is not input by a user while the composite image is displayed for a predetermined period of time.

14. The image apparatus as claimed in claim 9, wherein, if another channel change command is input while the composite image is being displayed, the controller controls the display unit to display another composite image in which the first broadcast is displayed as the main image and a third broadcast received via a third channel is displayed as the sub-image.

15. The image apparatus as claimed in claim 14, wherein the controller controls the display unit to display only the third broadcast if a command is not input by a user while the other composite image is displayed for a predetermined period of time.

16. The image apparatus as claimed in claim 9, wherein the controller controls the display unit to display only the second broadcast after the composite image is continuously displayed for a predetermined period of time.

17. A method for controlling an image apparatus, the method comprising:
determining whether an image source change command is input while a first image is being displayed;
if it is determined that the image source change command is input, displaying a composite image including the first image and a second image which is provided in response to the image source change command; and
selectively displaying only the second image after displaying the composite image.

18. The method as claimed in claim 17, wherein in the composite image, the first broadcast is displayed as a main image and a second broadcast received via a second channel is displayed as a sub-image

19. The method as claimed in claim 18, wherein the main image and the sub-image are displayed in a picture-in-picture (PIP) form.

20. The method as claimed in claim 18, wherein the selectively displaying only the second image comprises displaying only the second image if it is determined that a command to confirm change of an image source is input.
